(19) United States
(12) Patent Application Publication
(10) Pub. No.: US 2020/0179797 A1
(43) Pub. Date: Jun. 11, 2020

(54) INTERACTIVE SYSTEMS AND METHODS OF USING SAME

(71) Applicant: TAKARO TECH LTD., Herzeliya (IL)

(72) Inventor: Jonathan SHEM-UR, Tel Aviv (IL)

(73) Assignee: TAKARO TECH LTD., Herzeliya (IL)

(21) Appl. No.: 16/309,563

(22) PCT Filed: Jun. 14, 2017
(86) PCT No.: PCT/IL2017/050659

§ 371 Date: Dec. 13, 2018

Related U.S. Application Data
(60) Provisional application No. 62/349,743, filed on Jun. 14, 2016.

(51) Int. Cl. A63F 13/2145; G06F 3/044; A63F 13/217; A63F 13/211; A63F 13/335

(52) U.S. Cl. CPC A63F 13/2145; G06F 3/044; A63F 13/217; A63F 2300/1068; A63F 13/335; G06F 2203/04104; A63F 13/211

(57) ABSTRACT

The present invention provides an interactive system comprising at least one interactive visual display surface, at least one interactive computer being interconnected to said surface comprising an operating system and methods of operating the same.

### FIELD OF THE INVENTION

The present invention provides an interactive system employing an interactive surface for use in receiving, sending and displaying graphical input.

### BACKGROUND ART

References considered to be relevant as background to the presently disclosed subject matter are listed below:
US 2011234493
US 2006267952
CN 201042620

Acknowledgement of the above references herein is not to be inferred as meaning that these are in any way relevant to the patentability of the presently disclosed subject matter.

### GENERAL DESCRIPTION

The present invention provides an interactive system comprising: at least one interactive visual display surface; at least one interactive computer being interconnected to said surface comprising an operating system; wherein said at least one surface is configured to sense at least one parameter of at least one object on said surface; send to said at least one interactive computer, at least one digital input data based on said at least one parameter; receive at least one digital output data from said at least one interactive computer; and wherein said at least one digital output data comprises at least one graphical information; and display said at least one graphical information on said at least one interactive surface; wherein said at least one parameter is selected from impact of said object on said surface, location of object on said surface, velocity of object on said surface, heat of object on said surface, height of object from said surface and any combination thereof.

The term “interactive system” should be understood to encompass a system being in coordinated interaction with at least one user operating it, at least one interactive visual display surface and at least one interactive computer and any communications.

The term “interactive visual display surface” should be understood to encompass any surface that is capable of displaying an interface that is received from the at least one interactive computer and is capable of sensing at least one parameter of an object placed on said surface, comprising impact of said object on said surface, velocity of object on said surface, heat of object on said surface, location of object on said surface, height of object from said surface and any combination thereof. The surface can send to said at least one interactive computer, at least one digital input data based on said at least one parameter; receive at least one digital output data from said at least one interactive computer; and wherein said at least one digital output data comprises at least one graphical information; and display said at least one graphical information on said at least one interactive surface.

In some embodiments, said interactive visual display surface is connected directly to the internet (using any type of communication technology such as for example Wi-Fi technology, Bluetooth technology and so forth).

In some further embodiments said interactive visual display surface is an assembly of two and more (at least two) visual display surfaces interconnected between them to provide a uniform display surface, connectively displaying said graphical information. Under these embodiments, said at least two interactive visual display surfaces provide together the entire graphical information.

The term “object” should be understood to encompass any three-dimensional object that is placed on said surface and can create at least one parameter sensed by said surface. Said object may be a still object moved by the user on the surface of said system. In other embodiments said object is the body of the user himself that is moving on the surface of said system.

Said at least one interactive surface comprises at least one sensor configured to sense said at least one parameter of at least one object on said surface. In some embodiments said at least one sensor is an electrooptic sensor (in some embodiments said sensor can detect the difference in light shad and/or light intensity on said interactive surface and thus detect a parameter of said object on said surface, such as for example the location of said object, the velocity of said object and so forth). In some further embodiments said sensor is embedded and/or integrated within said interactive surface.

Said at least one interactive surface sends to said at least one interactive computer, at least one digital input data based on said at least one parameter, after which it receives at least one digital output data including at least one graphical information, from said at least one interactive computer. The interactive surface then displays said at least one graphical information.

Said user interaction includes, but is not limited to any type of parameter of the user on said at least one interactive visual display surface as for example impact, location of object on said surface, velocity, heat, height and so forth and any combination thereof. Said at least one interactive visual display surface is configured to sense at least one parameter on said surface thereby sending to said at least one interactive computer at least one digital input data based on said at least one parameter. Said at least one interactive visual display surface receives at least one digital output data from said at least one interactive computer which comprises at least one graphical information being displayed as an at least one graphical information on said at least one interactive surface.

In some embodiments, said interactive computer can further receive input from at least two interactive visual display surfaces.

In further embodiments, said at least one output data further comprises at least one audio signal information.

In other embodiments, said at least one interactive surface comprises a capacitive multi-touch LED display surface or any other type of display technology.

In further embodiments, said at least one interactive computer is also connected to the web network. In some other embodiments, at least one interactive computer is selected from a hand-held computer, a portable computer, a stationary computer, a cell phone, a tablet computer, a game console or any combinations thereof.

In other embodiments, said at least one interactive surface and/or at least one interactive computer comprises at least one transponder. Said transponder is capable of transmitting information between at least one interactive surface and at least one interactive computer.

In other embodiments, said operating system on said at least one interactive computer is programmed to provide an interactive CGI display on said at least one interactive visual display. In other embodiments, said program providing an interactive CGI display on said at least one interactive visual display is a computer game program.

In other embodiments, said program providing an interactive CGI display on said at least one interactive visual display is a computer interactive program.

In further embodiments, said at least one interactive visual display surface is placed on the ground.

In other embodiments, said system comprises at least two interactive visual display surfaces. In further embodiments, said at least two interactive visual display surfaces are perpendicular to each other.

In some other embodiments, said at least one interactive visual display surface has the size of at least about 0.40 m×0.40 m.

In further embodiments, said at least one interactive visual display surface has the size of at least about 1 m×2 m.

In further embodiments, said at least one interactive visual display surface can be connected to one or more interactive visual display surface to establish a bigger surface.

In another aspect, the invention provides a method of operating an interactive program with at least one user; said method comprises: providing an interactive system comprising at least one interactive visual display surface; at least one interactive computer being interconnected to said surface comprising an operating system; wherein said at least one surface is configured to sense at least one parameter; send to said at least one interactive computer, at least one digital input data based on said at least one parameter; receive at least one digital output data from said at least one interactive computer; wherein said at least one digital output data comprises at least one graphical information; and display said at least one graphical information through said at least one interactive surface; displaying on said interactive surface an interactive graphical display created by said operating system of said at least one interactive computer; sensing at least one parameter of at least one user by said at least one interactive surface and any parameters thereof; generating at least one digital input data based on said at least one parameter and parameters thereof; sending at least one digital input data to said at least one interactive computer; generating at least one digital output data by said operating system on said at least one interactive computer; sending said at least one digital output data from said interactive computer to said at least one interactive surface; displaying graphically using said interactive graphical display on said interactive surface said at least one digital output data on said interactive surface.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows an illustration of an embodiment of the system of the invention.

FIG. 2 shows an illustration of another embodiment of a system of the invention.

### DETAILED DESCRIPTION OF EMBODIMENTS

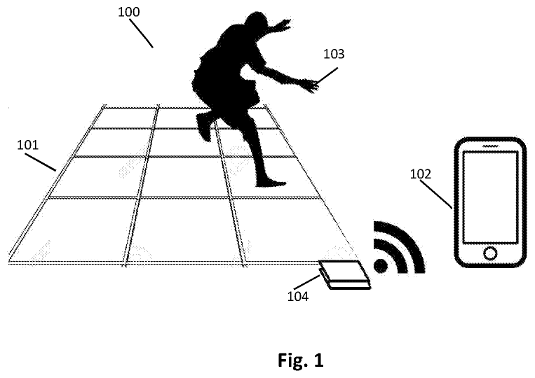

FIG. 1 is a schematic embodiment of an interactive system of the invention. The system of FIG. 1 (100) comprises an interactive visual display surface (101); an interactive mobile computer (102) both being interconnected to each other using an operating system and at least one transponder (104). The surface (101) is configured to sense at least one parameter on said surface by a user (103) stepping or touching it, then sending to said interactive computer at least one digital input data based on said at least one parameter. The computer (102) generates at least one digital output data which is received by said surface which is translated to at least one graphical information displayed on said interactive surface.

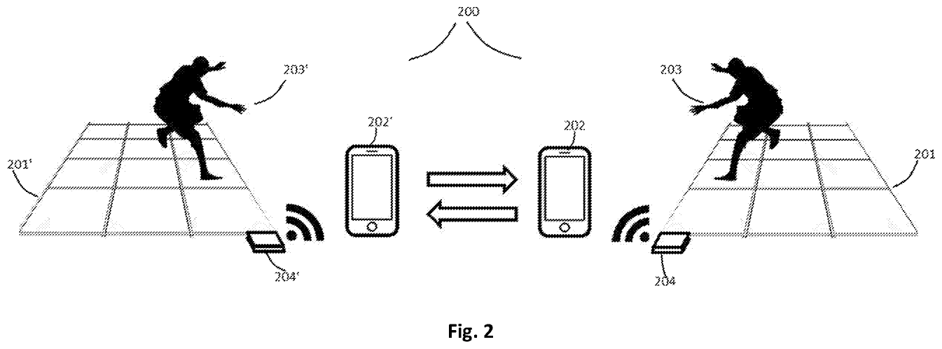

FIG. 2 depicts another embodiment of a system of the invention (200), which comprises two interactive visual display surfaces (201 and 201′); two interactive mobile computers (202 and 202′) each being interconnected to the each other using an operating system and at least one transponder (204 and 204′) for each. The surfaces (201 and 201′) are configured to sense at least one parameter on said corresponding surface by two individual users (203 and 203′) stepping or touching each corresponding, then each sending to said interactive computer at least one digital input data based on said at least one parameter of both users. The computers (202 and 202′) generate at least one digital output data which is received by both surfaces which is translated to at least one graphical information displayed on both interactive surfaces.

1. An interactive system comprising:
at least one interactive visual display surface;
at least one interactive computer being interconnected to said surface comprising an operating system;
wherein said at least one surface is configured to sense at least one parameter on said surface; send, to said at least one interactive computer, at least one digital input data based on said at least one parameter; receive at least one digital output data from said at least one interactive computer;
wherein said at least one digital output data comprises at least one graphical information; and display said at least one graphical information on said at least one interactive surface;
wherein said at least one parameter is selected from impact of said object on said surface, location of object on said surface, velocity of object on said surface, heat of object on said surface, height of object from said surface and any combination thereof.

2. The system of claim 1, wherein the interactive computer further receive input from at least two interactive visual display surfaces.

3. The system of claim 1, wherein said at least one output data further comprises at least one audio signal information.

4. The system of claim 1, wherein said at least one interactive surface comprises a capacitive multi-touch LED display surface.

5. The system of claim 1, wherein said at least one interactive computer is also connected to the web network.

6. The system of claim 1, wherein said operating system on said at least one interactive computer is programmed to provide an interactive CGI display on said at least one interactive visual display.

7. (canceled)

8. The system of claim 1, wherein said at least one interactive visual display surface is placed on the ground.

9. The system of claim 1, comprising at least two interactive visual display surfaces.

10. (canceled)

11. The system of claim 1, wherein said at least one interactive visual display surface has the size of at least about 0.40 m×0.40 m.

12. The system of claim 1, wherein said at least one interactive visual display surface has the size of at least about 1 m×2 m.

13. A method of operating an interactive program with at least one user; said method comprises:
providing an interactive system comprising at least one interactive visual display surface; at least one interactive computer being interconnected to said surface comprising an operating system; wherein said at least one surface is configured to sense at least one parameter; send to said at least one interactive computer, at least one digital input data based on said at least one parameter; receive at least one digital output data from said at least one interactive computer; wherein said at least one digital output data comprises at least one graphical information; and display said at least one graphical information through said at least one interactive surface;
displaying on said interactive surface an interactive graphical display created by said operating system of said at least one interactive computer;
sensing at least one parameter of at least one user by said at least one interactive surface and any parameters thereof;
generating at least one digital input data based on said at least one parameter and parameters thereof;
sending at least one digital input data to said at least one interactive computer;
generating at least one digital output data by said operating system on said at least one interactive computer;
sending said at least one digital output data from said interactive computer to said at least one interactive surface;
displaying graphically using said interactive graphical display on said interactive surface said at least one digital output data on said interactive surface.

14. The method of claim 13, wherein said interactive computer can further receive input from at least two interactive visual display surfaces.

15. The method of claim 13, wherein said at least one output data further comprises at least one audio signal information.

16. The method of claim 13, wherein said at least one interactive surface comprises a capacitive multi-touch LED display surface.

17. The method of claim 13, wherein said at least one interactive computer is also connected to the web network.

18. The method of claim 13, wherein said operating system on said at least one interactive computer is programmed to provide an interactive CGI display on said at least one interactive visual display.

19. The method of claim 13, wherein said program providing an interactive CGI display on said at least one interactive visual display is a computer game program.

20. The method of claim 13, wherein said at least one interactive visual display surface is placed on the ground.

21. The method of claim 13, wherein said at least one interactive visual display surface has the size of at least about 0.40 m×0.40 m.

22. The method of claim 13, wherein said at least one interactive visual display surface has the size of at least about 1 m×2 m.
